(19) United States
(12) Patent Application Publication
(10) Pub. No.: US 2025/0373913 A1
(43) Pub. Date: Dec. 4, 2025

(54) Computing System with Personalized Educational Content Generation Feature

(71) Applicant: Roku, Inc., San Jose, CA (US)

(72) Inventors: Ritwick Babbar, Fremont, CA (US); Thejaswi Hanumantha Raya, Fremont, CA (US); Sunil Ramesh, Cupertino, CA (US); Karina Levitian, Austin, TX (US)

(21) Appl. No.: 18/732,183

(22) Filed: Jun. 3, 2024

(51) Int. Cl. H04N 21/8545; G06Q 50/20

(52) U.S. Cl. CPC H04N 21/8545; G06Q 50/20

(57) ABSTRACT

In one aspect, an example method includes (i) determining, by a computing system, an extent of a user's understanding of one or more educational topics; (ii) using, by the computing system, at least the determined extent of the user's understanding of one or more educational topics to generate a personalized curriculum for the user; (iii) using, by the computing system, at least the generated personalized curriculum and one or more trained machine learning (ML) models, to generate personalized educational media content for the user; and (iv) performing, by the computing system, a set of operations to facilitate outputting for presentation via a user interface, the generated personalized educational media content for the user.

In this disclosure, unless otherwise specified and/or unless the particular context clearly dictates otherwise, the terms “a” or “an” mean at least one, and the term “the” means the at least one.

### SUMMARY

In one aspect, an example method is disclosed. The method includes (i) determining, by a computing system, an extent of a user's understanding of one or more educational topics; (ii) using, by the computing system, at least the determined extent of the user's understanding of one or more educational topics to generate a personalized curriculum for the user; (iii) using, by the computing system, at least the generated personalized curriculum and one or more trained machine learning (ML) models, to generate personalized educational media content for the user; and (iv) performing, by the computing system, a set of operations to facilitate outputting for presentation via a user interface, the generated personalized educational media content for the user.

In another aspect, an example computing system is disclosed. The computing system includes a processor and a non-transitory computer-readable medium having stored thereon program instructions that upon execution by the processor, cause performance of a set of acts including: (i) determining, by the computing system, an extent of a user's understanding of one or more educational topics; (ii) using, by the computing system, at least the determined extent of the user's understanding of one or more educational topics to generate a personalized curriculum for the user; (iii) using, by the computing system, at least the generated personalized curriculum and one or more trained machine learning (ML) models, to generate personalized educational media content for the user; and (iv) performing, by the computing system, a set of operations to facilitate outputting for presentation via a user interface, the generated personalized educational media content for the user.

In another aspect, a non-transitory computer-readable medium is disclosed. The non-transitory computer-readable medium has stored thereon program instructions that upon execution by a processor, cause performance of a set of acts including (i) determining, by the computing system, an extent of a user's understanding of one or more educational topics; (ii) using, by the computing system, at least the determined extent of the user's understanding of one or more educational topics to generate a personalized curriculum for the user; (iii) using, by the computing system, at least the generated personalized curriculum and one or more trained machine learning (ML) models, to generate personalized educational media content for the user; and (iv) performing, by the computing system, a set of operations to facilitate outputting for presentation via a user interface, the generated personalized educational media content for the user.

### BRIEF DESCRIPTION OF THE DRAWINGS

FIG. 1 is a simplified block diagram of an example content system in which various described principles can be implemented.

FIG. 2 is a simplified block diagram of an example computing system in which various described principles can be implemented.

FIG. 3 is a diagram that illustrates an example personalized curriculum for a user.

FIG. 4A is a diagram that illustrates example interactive media content.

FIG. 4B is a diagram that illustrates other example interactive media content.

FIG. 5 is a flow chart of an example method.

FIG. 6 is a flow chart of another example method.

### DETAILED DESCRIPTION

### I. Overview

Given the increasingly large amount of educational media content (e.g., an educational video relating to a given school subject, such as physics) that is now available to users, it has become especially important for content providers to generate and/or curate educational media content that users find relevant, so that users will be more inclined to choose that content over other options. However, producing and/or curating such content can be complicated time-consuming, and/or expensive.

Disclosed herein are techniques that can allow a computing system to determine an extent of a user's understanding of one or more educational topics, and that leverage at least this, together with one or more machine learning (ML) models, to generate and facilitate outputting personalized educational media content tailored to the user. In this way, the content system can help address the issues noted above, and can efficiently generate and curate personalized educational media content that users find relevant.

More specifically, according to one example implementation, a computing system can (i) determine an extent of a user's understanding of one or more educational topics; (ii) use at least the determined extent of the user's understanding of one or more educational topics to generate a personalized curriculum for the user; (iii) use at least the generated personalized curriculum and one or more trained machine learning (ML) models, to generate personalized educational media content for the user; and (iv) perform a set of operations to facilitate outputting for presentation via a user interface, the generated personalized educational media content for the user. These and related operations, systems, and features will now be describe in greater detail.

### II. Example Architecture

### A. Content System

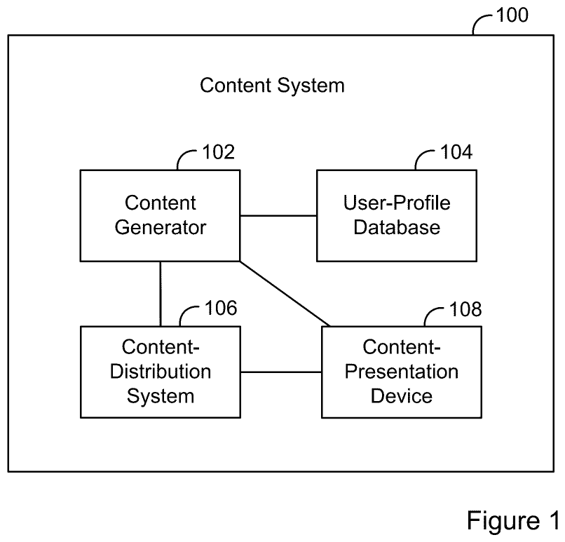

FIG. 1 is a simplified block diagram of an example content system 100. Generally, the content system 100 can perform operations related to various types of media content, such video content and/or audio content.

Video content can be represented by video data, which can be generated, stored, and/or organized in various ways and according to various formats and/or protocols, using any related techniques now known or later discovered. For example, the video content can be generated by using a camera and/or other equipment to capture or record a live-action event. In other examples, the video content can be synthetically generated, such as by using one or more of the techniques described in this disclosure, or by using any related video content generation techniques now known or later discovered.

As noted above, video data can also be stored and/or organized in various ways. For example, video data can be stored and organized as a Multimedia Database Management System (MDMS) and/or in various digital file formats, such as the MPEG-4 format, among numerous other possibilities.

The video data can represent the video content by specifying various properties of the video content, such as luminance, brightness, and/or chrominance values, and/or derivatives thereof. In some instances, the video data can be used to generate the represented video content. But in other instances, the video data can be a fingerprint or signature of the video content, which represents the video content and/or certain characteristics of the video content and which can be used for various purposes (e.g., to identify the video content or characteristics thereof), but which is not sufficient at least on its own to generate the represented video content.

In some instances, video content can include an audio content component and/or metadata associated with the video and/or audio content. In the case where the video content includes an audio content component, the audio content is generally intended to be presented in sync together with the video content. To help facilitate this, the video data can include metadata that associates portions of the video content with corresponding portions of the audio content. For example, the metadata can associate a given frame or frames of video content with a corresponding portion of audio content. In some cases, audio content can be organized into one or more different channels or tracks, each of which can be selectively turned on or off, or otherwise controlled.

In some instances, video content (with or without an audio content component) can be made up one or more video segments. For example, in the case where the video content is a video about a given topic, the video content may be made up of multiple segments, each relating to a different subtopic of that topic.

In some instances, the media content can be passive, but in other instances, it can include an interactive component. In this way, a user can interact with the media content in various ways, such as with a remote controller or other user interface. In some examples, the media content can be educational media content geared towards educating one or more end-users.

Returning to the content system 100, this can include various components, such as a content generator 102, a user-profile database 104, a content-distribution system 106, and a content-presentation device 108. The content system 100 can also include one or more connection mechanisms that connect various components within the content system 100. For example, the content system 100 can include the connection mechanisms represented by lines connecting components of the content system 100, as shown in FIG. 1.

In this disclosure, the term “connection mechanism” means a mechanism that connects and facilitates communication between two or more components, devices, systems, or other entities. A connection mechanism can be or include a relatively simple mechanism, such as a cable or system bus, and/or a relatively complex mechanism, such as a packet-based communication network (e.g., the Internet). In some instances, a connection mechanism can be or include a non-tangible medium, such as in the case where the connection is at least partially wireless. In this disclosure, a connection can be a direct connection or an indirect connection, the latter being a connection that passes through and/or traverses one or more entities, such as a router, switcher, or other network device. Likewise, in this disclosure, a communication (e.g., a transmission or receipt of data) can be a direct or indirect communication.

The content-distribution system 106 and its means of transmission of media content on the channel to the content-presentation device 108 can take various forms. By way of example, the content-distribution system 106 can be an Internet-based distribution system that transmits the media content using a media content streaming-type service or the like to the content-presentation device 108. As another example, the content-distribution system 106 can be or include a cable-television head-end that is associated with a cable-television provider and that transmits the media content on the channel to the content-presentation device 108 through hybrid fiber/coaxial cable connections. As another example, the content-distribution system 106 can be or include a satellite-television head-end that is associated with a satellite-television provider and that transmits the media content on the channel to the content-presentation device 108 through a satellite transmission. As yet another example, the content-distribution system 106 can be or include a television-broadcast station that is associated with a television-broadcast provider and that transmits the content on the channel through a terrestrial over-the-air interface to the content-presentation device 108. In these and other examples, the content-distribution system 106 can transmit the content in the form of an analog or digital broadcast stream representing the media content. Also, in these or other examples, the content-distribution system 106 can be associated with a single channel content distributor or a multi-channel content distributor such as a multi-channel video program distributor (MVPD).

The content-presentation device 108 can receive media content from one or more entities, such as the content-distribution system 106. In one example, the content-presentation device 108 can select (e.g., by tuning to) a channel from among multiple available channels, perhaps based on input received via a user interface, such that the content-presentation device 108 can receive media content on the selected channel.

In some examples, the content-distribution system 106 can transmit media content to the content-presentation device 108, which the content-presentation device 108 can receive. The content-presentation device 108 can also output media content for presentation. As noted above, the content-presentation device 108 can take various forms. In one example, in the case where the content-presentation device 108 is a television set (perhaps with an integrated set-top box and/or streaming media stick), outputting the media content for presentation can involve the television set outputting the media content via a user interface (e.g., a display device and/or a sound speaker), such that it can be presented to an end-user. As another example, in the case where the content-presentation device 108 is a set-top box or a streaming media stick, outputting the media content for presentation can involve the set-top box or the streaming media stick outputting the media content via a communication interface (e.g., an HDMI interface), such that it can be received by a television set and in turn output by the television set for presentation to an end-user.

As such, in various scenarios, the content-distribution system 106 can transmit media content to the content-presentation device 108, which can receive and output the media content for presentation to an end-user.

In some instances, the content system 100 can include multiple instances of at least some of the described components. The content system 100 and/or components thereof can take the form of a computing system, an example of which is described below.

### B. Computing System

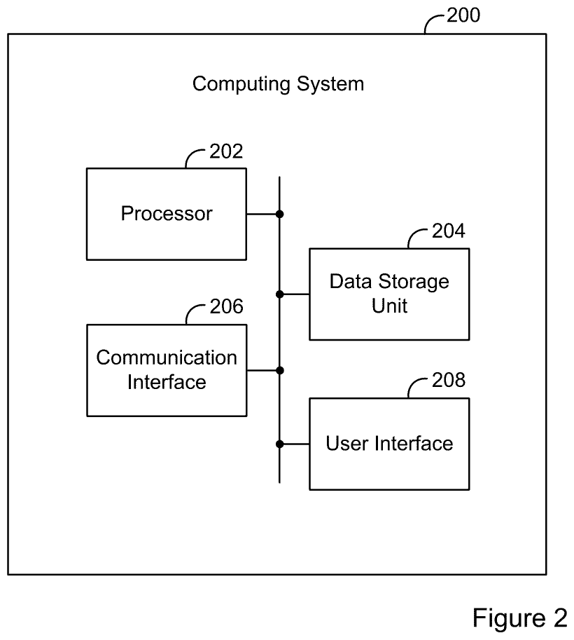

FIG. 2 is a simplified block diagram of an example computing system 200. The computing system 200 can be configured to perform and/or can perform one or more operations, such as the operations described in this disclosure. The computing system 200 can include various components, such as a processor 202, a data-storage unit 204, a communication interface 206, and/or a user interface 208.

The processor 202 can be or include a general-purpose processor (e.g., a microprocessor) and/or a special-purpose processor (e.g., a digital signal processor). The processor 202 can execute program instructions included in the data-storage unit 204 as described below.

The data-storage unit 204 can be or include one or more volatile, non-volatile, removable, and/or non-removable storage components, such as magnetic, optical, and/or flash storage, and/or can be integrated in whole or in part with the processor 202. Further, the data-storage unit 204 can be or include a non-transitory computer-readable storage medium, having stored thereon program instructions (e.g., compiled or non-compiled program logic and/or machine code) that, upon execution by the processor 202, cause the computing system 200 and/or another computing system to perform one or more operations, such as the operations described in this disclosure. These program instructions can define, and/or be part of, a discrete software application.

In some instances, the computing system 200 can execute program instructions in response to receiving an input, such as an input received via the communication interface 206 and/or the user interface 208. The data-storage unit 204 can also store other data, such as any of the data described in this disclosure.

The communication interface 206 can allow the computing system 200 to connect with and/or communicate with another entity according to one or more protocols. Therefore, the computing system 200 can transmit data to, and/or receive data from, one or more other entities according to one or more protocols. In one example, the communication interface 206 can be or include a wired interface, such as an Ethernet interface, a High-Definition Multimedia Interface (HDMI), or a Universal Serial Bus (USB) interface. In another example, the communication interface 206 can be or include a wireless interface, such as a cellular or WI-FI interface.

The user interface 208 can allow for interaction between the computing system 200 and a user of the computing system 200. As such, the user interface 208 can be or include an input component such as a keyboard, a mouse, a remote controller, a microphone, and/or a touch-sensitive panel. The user interface 208 can also be or include an output component such as a display device (which, for example, can be combined with a touch-sensitive panel) and/or a sound speaker.

The computing system 200 can also include one or more connection mechanisms that connect various components within the computing system 200. For example, the computing system 200 can include the connection mechanisms represented by lines that connect components of the computing system 200, as shown in FIG. 2.

The computing system 200 can include one or more of the above-described components and can be configured or arranged in various ways. For example, the computing system 200 can be configured as a server and/or a client (or perhaps a cluster of servers and/or a cluster of clients) operating in one or more server-client type arrangements, for instance.

As noted above, the content system 100 and/or components thereof can take the form of a computing system, such as the computing system 200. In some cases, some or all these entities can take the form of a more specific type of computing system, such as a desktop computer, a laptop, a tablet, a mobile phone, a television, a set-top box, a content streaming stick, a head-mountable display device (e.g., a virtual-reality headset or a augmented-reality headset), or various combinations thereof, among other possibilities.

### III. Example Operations

The content system 100 and/or components thereof can be configured to perform and/or can perform one or more operations. As noted above, generally, the content system 100 can perform operations related to various types of media content, such as educational media content that can take various forms, including passive or interactive video content. The content system 100 can also perform other operations. Various example operations that the content system 100 can perform, and related features, will now be described with reference to various figures.

Generally, the content system 100 can determine an extent of a user's understanding of one or more educational topics, and can leverage at least this, together with one or more ML models, to generate and facilitate outputting personalized educational media content for the user. For instance, the content generator 102 can (i) determine an extent of a user's understanding of one or more educational topics; (ii) use at least the determined extent of the user's understanding of one or more educational topics to generate a personalized curriculum for the user; (iii) use at least the generated personalized curriculum and one or more trained ML models, to generate personalized educational media content for the user; and (iv) perform a set of operations to facilitate outputting for presentation via a user interface, the generated personalized educational media content for the user. These and other related operations and features will now be described in greater detail.

To begin, the content generator 102 can determine an extent of a user's understanding of one or more educational topics. For context, there can be a variety of educational topics within different settings. For example, in an academic setting, an educational topic can include a given school subject (e.g., physics) or one or more particular areas of focus or concepts within that subject (e.g., simple machines, or a specific types of simple machine, such as levers, inclined planes, or pulleys). As another example, in a workplace setting, an educational topic can include a workplace function (e.g., a new employee onboarding process) or one or more particular areas of focus or concepts within that function (e.g., a procedure for obtaining a building elevator pass, a procedure for enrolling in company insurance programs, or a procedure for logging into a company computing system). In some examples, the content generator 102 can first select the one or more educational topics (e.g., based on user input received via a user interface), and then the content generator 102 can then determine the extent of the user's understanding of the selected one or more educational topics (or subtopics within those topics).

The extent of the user's understanding of one or more educational topics can be represented in various ways, such as by way of a score for each of the one or more educational topics, where the score indicates the extent of the user's understanding of that topic. Accordingly, in one example, determining the extent of the user's understanding of one or more educational topics can involve, for each of the one or more educational topics, determining a respective score indicating the extent of the user's understanding of that educational topic.

For example, consider an example in which a score between 1-100 is assigned to each topic, with the score of 1 indicating a lowest extent of understanding of the topic and a score of 100 indicating a highest extent of understanding of the topic. In one example, scores for the educational topics of levers, inclined planes, and pulleys could be 8, 22, and 86, respectively. This could indicate that the user has a fairly low extent of understanding of levers, a relatively higher, but still fairly low extent of understanding of inclined planes, and a fairly high extent of understanding of pulleys, as just one example.

The content generator 102 can determine the extent of the user's understanding of one or more educational topics in various ways. For instance, in one example, this can involve the content generator 102 receiving user input indicating the extent of the user's understanding of one or more educational topics and then using the received user input to determine the extent of the user's understanding of the one or more educational topics. In practice, this can allow the user to specify scores for respective topics, or to provide other input that can represent the user's understanding of one or more educational topics. In some cases, the content generator 102 can use one or more rules or other techniques to map user input to scores.

In another example, the content generator 102 determining the extent of the user's understanding of one or more educational topics can involve providing the user with a questionnaire and receiving corresponding user input indicating answers to the questionnaire, and using the received user input to determine the extent of the user's understanding of one or more educational topics.

The questionnaire can take various forms. For example, the questionnaire can be an adaptive test that presents one or more questions to a user and that uses responses to the one or more questions to drive the selection of one or more further questions that are presented to the user, such that this process can repeat itself one or more times. In some configurations, this might result in correct answers causing the content generator 102 to present more challenging questions that dive further into a given topic, whereas incorrect answers might cause the content generator 102 to present less challenging questions about the topic or perhaps questions about different topics. As another example, the questionnaire can be a diagnostic test that asks series of pre-defined questions aimed and allowing the content generator 102 to understand where the user shows gaps in understanding of a given topic. These are just a few examples. Various other types of questionnaires could be used as well.

The content generator 102 can then use the received user input to determine the extent of the user's understanding of one or more educational topics in various ways. For example, in one example, each question can be associated with one or more such topics, such that the correct or incorrect answers to certain questions can be used, perhaps based on one or more rules, to determine corresponding scores for those topics.

In another example, the content generator 102 determining the extent of the user's understanding of one or more educational topic can involve the content generator 102 determining a content consumption history of the user and using the determined content consumption history to determine the extent of the user's understanding of one or more educational topics. In connection with this concept, the content generator 102 can determine, store, maintain, and/or access content consumption history data, which can indicate information such as what specific media content (e.g., educational media content) the user has consumed, how many times the user has consumed it, the extent to which the user re-watch certain parts of it, etc.

In another example, the content generator 102 determining the extent of the user's understanding of one or more educational topic can involve the content generator 102 determining a content interaction history of the user and using the determined content interaction history to determine the extent of the user's understanding of one or more educational topics. In connection with this concept, the content generator 102 can determine, store, maintain, and/or access content interaction data, which can indicate information such as how the user interacted with specific interactive media content or components thereof, how often the user did so, etc.

In another example, the content generator 102 determining the extent of the user's understanding of one or more educational topic can involve the content generator 102 determining a content engagement history of the user and using the determined content engagement history to determine the extent of the user's understanding of one or more educational topics. In connection with this concept, the content generator 102 can determine, store, maintain, and/or access content engagement data, which can indicate an extent of engagement of the user with respect to the media content being presented. There can be various types of content engagement data. For example, the content engagement data could indicate an extent to which the body, face, and/or eye gaze of the user is oriented and/or directed towards the content-presentation device 108 presenting the media content, an extent to which the user is moving, an extent to which the user is using a device other than the content-presentation device 108, an extent to which the user is eating or drinking, an extent to which the user is engaging in interpersonal activity (e.g., talking to another person), and/or facial expressions of the user (e.g., an expression suggesting that the user may be confused when a given language is being spoken), among numerous other possibilities, each of which may relate to the extent of the person's engagement with the media content being presented.

The content generator 102 can determine a content consumption history of the user, a content interaction history of the user, and/or a content engagement history of the user in various ways, such as by using any techniques now known or later discovered. In some cases, some or all of this data might be included as part of user profile data for the user, and stored in the user-profile database 104 and then later retrieved from that database as used as noted above, as one example.

Moreover, the content generator 102 can use the determined content consumption history of the user, content interaction history of the user, and/or content engagement history to determine the extent of the user's understanding of one or more educational topics in various ways, such as by applying one or more rules (which might map certain behavior to a certain extent of the user's understanding) or by using other techniques.

In some examples, the content generator 102 can employ a machine learning technique, such as one that uses a deep neural network (DNN) to train an ML model to use content consumption history of the user, a content interaction history of the user, and/or a content engagement history of the user to determine the extent of the user's understanding of one or more educational topics. To do this, the content generator 102 can train the model with training input data, such as content consumption history data, content interaction history data, and/or content engagement history data, or other data as discussed above, all associated with given user and media content, along with along with corresponding training output data, such as a score indicating the user's extent of understanding of the media content.

In practice, for this and all example ML models disclosed herein, it is likely that large amounts of training data—perhaps thousands of training data sets or more—would be used to train the model as this generally helps improve the usefulness of the model. Moreover, training data can be generated in various ways, including by being manually assembled. However, in some cases, the one or more tools or techniques, including any training data gathering or organization techniques now known or later discovered, can be used to help automate or at least partially automate the process of assembling training data and/or training the model.

After the model is trained, the content generator 102 can then provide to the model runtime input data, which the model can use to generate runtime output data. Generally, the runtime input data is of the same type as the training input data as described above.

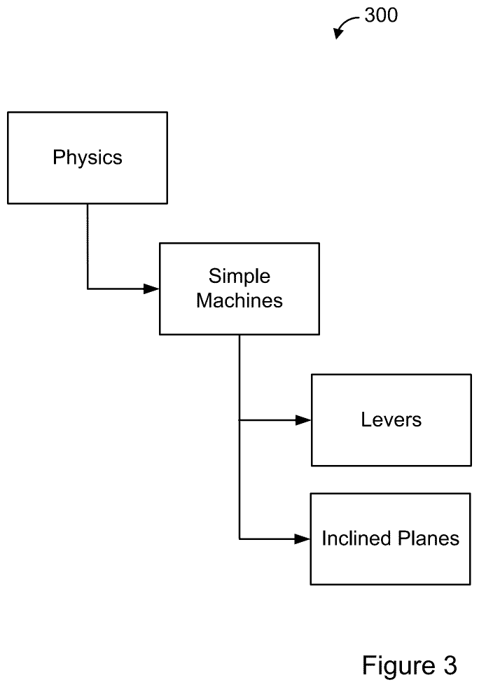

After the content generator 102 determines the extent of the user's understanding of one or more educational topics, the content generator 102 can use at least the determined extent of the user's understanding of one or more educational topics to generate a personalized curriculum for the user. The generated personalized curriculum could be represented in various ways. For example, it could be represented as curriculum data that is a list of educational topics. For example, continuing with the example discussed above in which it was determined that the user has a fairly low extent of understanding of levers, a relatively higher, but still fairly low extent of understanding of inclined planes, and a fairly high extent of understanding of pulleys, the curriculum data could be a list of the educational topics levers and inclined planes, but that excludes pulleys, as one simple example. In some cases, the curriculum data might also include the educational topics higher up in the hierarchy, such as simple machines, or physics, perhaps depending on the extent to which the user understands the subtopics in the aggregate, for example. FIG. 3 is a diagram that illustrates an example personalized curriculum 300 for a user, in line with the example noted above. It should be noted that this example personalized curriculum 300 is provided for illustration purposes only. In practice, a personalized curriculum could be far more complex. Notably, in some instances, the personalized curriculum might also specify additional metadata about each topics, such as a corresponding score to indicate the degree to which additional understanding may be needed.

In some cases, the determined extent of understanding of a topic might relate not just to that topic alone, but also to that topic's relationship to another topic. Likewise, in some examples, the curriculum data can indicate a relationship between two or more topics (e.g., where the user may lack an understanding of the relationship between two topics, regardless of the user's extent of understanding of the two topics individually).

In some examples, the personalized curriculum for the user could be represented as a knowledge graph, where the nodes of the graph represent educational topics and the edges between nodes represent the relationships between those topics. In that case, the knowledge graph could include weights associated with notes or edges, to indicate scores (indicating the user's extent of understanding) for the topics and/or relationships, for example.

In some examples, the content generator 102 can employ a machine learning technique, such as one that uses a DNN to train an ML model to use at least the determined extent of the user's understanding of one or more educational topics to generate a personalized curriculum for the user. To do this, the content generator 102 can train the model with training input data, such as the determined extent of the user's understanding of one or more educational topics along with corresponding training output data, such as curriculum data. After the ML model is trained, the content generator 102 can then provide to the model runtime input data, which the model can use to generate runtime output data. Generally, the runtime input data is of the same type as the training input data as described above.

After the content generator 102 generates the personalized curriculum for the user, the content generator 102 can use at least the generated personalized curriculum and one or more trained ML models, to generate personalized educational media content for the user. To do this, the content generator 102 can train one or more ML models with training input data, such as curriculum data along with corresponding training output data, such as corresponding media content (e.g., video content) or associated data, such as program instructions (i.e., software code, including code for an associated engine, such as a physics engine) for interactive media content, for example. After the ML model is trained, the content generator 102 can then provide to the model runtime input data, which the model can use to generate runtime output data. Generally, the runtime input data is of the same type as the training input data as described above.

Notably, in some cases, multiple ML models can be used together to generate media content. For instance, multiple ML models can be used to generate different media content components (e.g., images, text, etc.) which can be combined together to generate media content. Alternatively, one more ML models can be used to generate a given component, which can then be provided as input data into another ML model, which can then generate the media content, for example.

As such, in one example, using at least the generated personalized curriculum and one or more trained ML models to generate personalized educational media content for the user can involve: providing the generated personalized curriculum to a trained ML model; responsive to the providing, receiving from the trained ML model, program instructions for interactive media content related to the personalized curriculum; and using the received program instructions to generate the interactive media content. In this way, the ML model can generate program instructions that can be used to present interact media content for the user. For example, in the case where the personalized includes the educational topics levers, the ML model might generate program instructions that a computing system can use to generate interactive media content that helps a user understand how levers work.

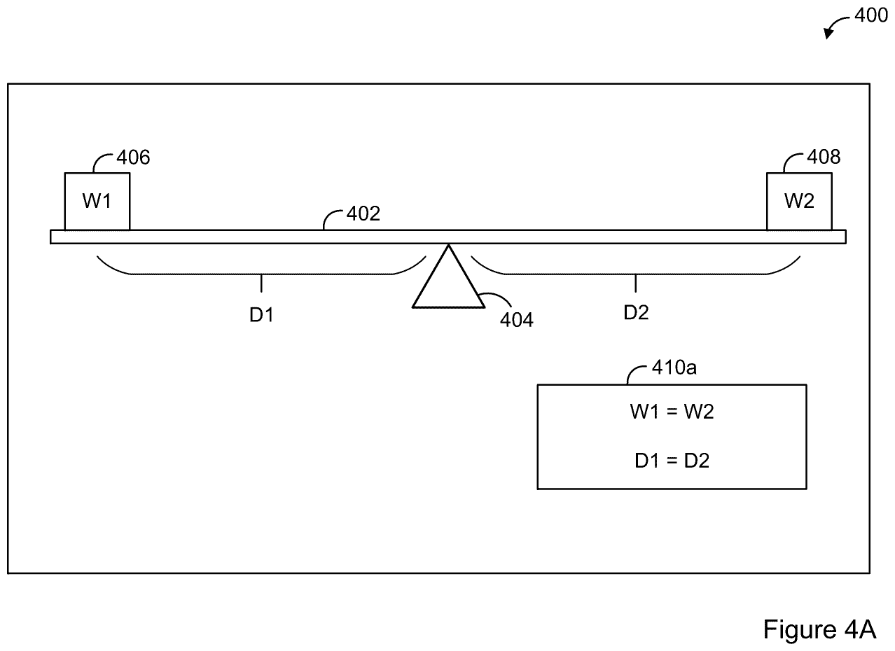

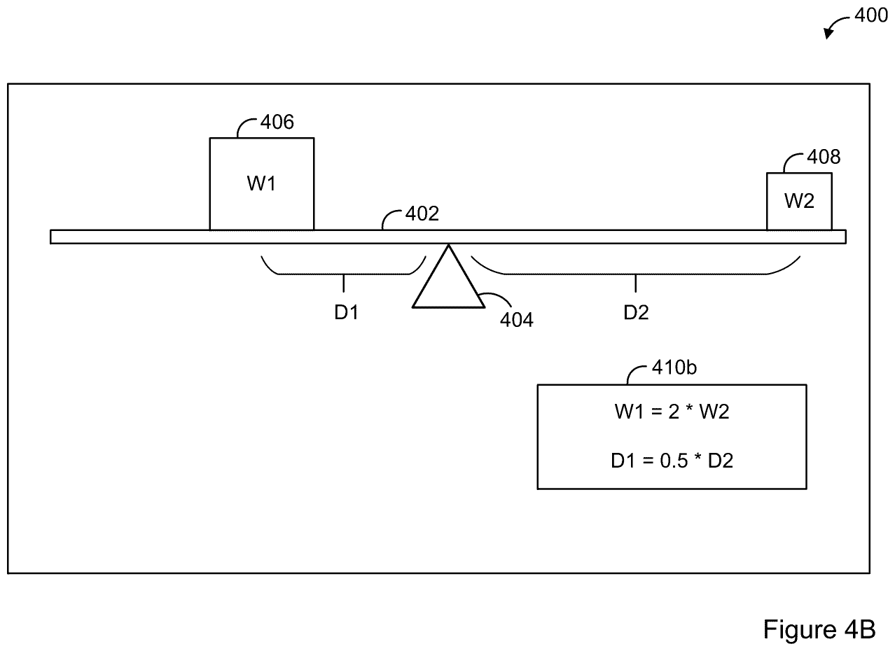

FIGS. 4A and 4B illustrate example interactive media content 400 (shown as two snapshots at different points in time) in line with the example above. As shown, the interactive media content 400 depicts a lever 402 balanced on a fulcrum 404, with the lever having a first weight W1 406 at a first position D1 (distance from the fulcrum) on one half of the lever 402, and a second weight W2 408 at a second position D2 on the other half of the lever 402. The interactive media content 400 may also include several data windows 410a and 410b that provide information related to these weights and positions.

Though not shown in the examples illustrated in FIGS. 4A and 4B, the interactive media content 400 may in some embodiments further include additional elements (e.g., text, underlying graphics, etc.) that add real-world context to the concept being presented, such as background images or specific objects used for the weights, either or both of which might be selected based on user profile data associated with the user, as just some examples.

Within the interactive media content 400, several elements may be interactive and thus can be manipulated by the user. For instance, the weights and corresponding positions can be modified by the user (e.g., by using a remote control device, mouse, or other user input device), such as by entering numerical values or by dragging a user interface element (e.g., by dragging a position of a given weight along the lever). Such related values may be displayed by way of the data windows 410a and 410b. For example, in FIG. 4A, W1 and W2 are shown to be equal to one another in data window 410a, while D1 and D2 are similarly set to be equal to one another. Due to this balance, the lever itself is balanced, which is also displayed in FIG. 4A.

In FIG. 4B, by contrast, W1 has been modified to be twice the value of W2, and D1 has been modified to be one-half the value of D2, as shown in data window 410b. Despite these changes, the lever is still balanced, which illustrates the physics principle of a moment of force, which is proportional to both the force (weight, in this example) and the pivot distance (the distance to the fulcrum, in this example), using the equation M=F*d, where M is the moment of force, F is the force, and d is the distance.

In some embodiments, the interactive media content 400 can be configured such that, in response to such modifications to the values as described above, the interactive media content 400 adjusts itself as appropriate (e.g., by altering the position of the lever, changing the size of the weights on the lever, or by updating the data displayed in the data windows 410a and 410b).

The example interactive media content 400 is just one example of interactive content for illustration purposes. In practice, the content generator 102 can generate various types of interactive media content with varying levels of complexity, and with varying features, interactive elements, and the like to suit a desired configuration. In some instances, components of the interactive media content can relate to multiple topics, or can have separate components, each corresponding to a different component, perhaps with a menu allowing the user the navigate between them. Various other configurations are possible as well.

In another example, using at least the generated personalized curriculum and one or more trained ML models, to generate personalized educational media content for the user can involve: providing the generated personalized curriculum to a trained ML model; and responsive to the providing, receiving from the trained ML model, generated video content related to the personalized curriculum. For example, in the case where the personalized includes the educational topic of levers, the ML model might generate video content that explains how levers work. Likewise, in the case where the personalized includes the educational topics of levers and inclined planes, the ML model might generate video content that explains how levers and inclined planes work, perhaps with one after the other, and/or perhaps with some component that covers aspect applicable to both levers and inclined planes combined together. Additionally or alternatively, various other types of media content (e.g., text-based media content, audio content, etc.) can be generated as well.

In connection with using one or more ML models to generate a personalized curriculum and/or personalized educational content, in some cases, the ML models can be trained with additional training input data, such that at runtime, the trained ML models can generate a personalized curriculum and/or personalized educational content that is even more tailored to the user. For example, such additional data might include user profile data that indicates a user's language preference, preferred teaching style, preferred leaning style, geographic location, and/or educational level, some or all of which can allow the content generator 102 to generate a personalized curriculum and/or personalized educational content that is tailored to the user based at least in part on those factors. Additionally or alternatively, in connection with generating a personalized curriculum and/or personalized educational content, the content system 102 might determine situations where a topic might be presented or understood differently in different geographic locations or the like and might flag such content in a manner to alert users to this fact.

As another example, such additional data might include user profile data that indicates a user's favorite movies, actors/actresses, characters, art style, music, hobbies, interests, or other information, some or all of which can allow the content generator 102 to generate a personalized curriculum and/or personalized educational content that is tailored to the user based on those factors. For instance, in connection with the lever example outlined in FIG. 4, such preferences could guide the selection of the seesaw concept generally, the specific people on the seesaw, the names of the people, the background image, etc. Such data could likewise be used as input when generating video content, to tailor the video content to the user's preferences.

Regarding the various ML models discussed in this disclosure, various different types of models can be used to suit a desired configuration, including any suitable ML model now known or later discovered. For instance, examples models that could include Large Language Models (LLM), Retrieval-Augmented Generation (RAG) models, and/or any type of video, audio, image, text and/or program instruction generation model. Examples of such models might include the Generative Pre-trained Transformer (GPT-3, GPT-3.5, GPT-4, or GPC-40) language model provided by OpenAI, the Chinchilla language model provided by DeepMind, the Sora video generation model provided by OpenAI, the DALL-E image generation model provided by OpenAI, and/or the Stable Diffusion image generation model provided by CompVis, among numerous other possibilities.

After the content generator 102 generates personalized educational media content for the user, the content generator 102 can perform a set of operations to facilitate outputting for presentation via a user interface, the generated personalized educational media content for the user.

In one example, this set of operations can include transmitting to the content-presentation device 108 the generated personalized educational media content and/or an instruction to cause the content-presentation device 108 to output for presentation the generated personalized educational media content.

In another example, this set of operations can include the content-distribution system 106 transmitting the generated personalized media content to the content-presentation device 108, which can receive and itself output for presentation the generated media content, such that it can present it to a user.

The content-presentation device 108 can then receive the instruction and/or the generated personalized media content from one or more entities, such as the content-distribution system 106, and can output the personalized media content for presentation.

In some instances, the content system 100 can include an editing system component that allows a user to review, approve, reject, and/or edit various operations or results of operations, as part of a quality assurance process. For instance, in the context of the content generator 102 performing the various operations described above, the editing system can allow a user of the editing system to review and approve (perhaps with some user input/editing) the related inputs/outputs.

In some examples, outputs of the techniques described above can also be used for other purposes, aside from generating and presenting media content to users. For instance, in the case where the content system 100 determines that a user has a given extent of understanding of a given language, the content system 100 can use that information as a basis to configure a lexicon used by a device (e.g., an Internet-of-Things (IoT) device associated with the user) that provides a voice assistant feature. In one example implementation, this can allow the voice assistant feature to expand or contract its lexicon based on the user's degree of understanding of the language, for instance.

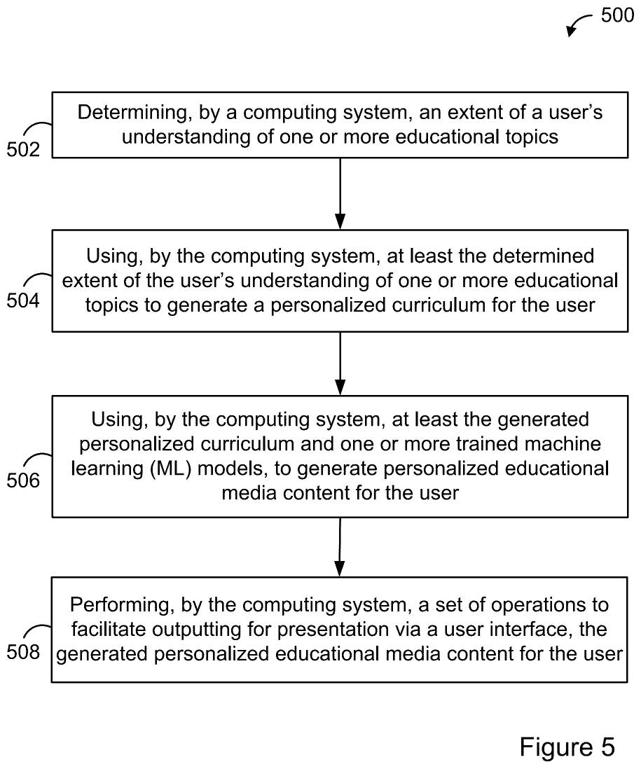

FIG. 5 is a flow chart illustrating an example method 500. The method 500 can be carried out by a content system, such as the content system 100, or by a component thereof, such as the content generator 102, or more generally, by a computing system, such as the computing system 200. At block 502, the method 500 includes determining, by a computing system, an extent of a user's understanding of one or more educational topics. At block 504, the method 500 includes using, by the computing system, at least the determined extent of the user's understanding of one or more educational topics to generate a personalized curriculum for the user. At block 506, the method 500 includes using, by the computing system, at least the generated personalized curriculum and one or more trained machine learning (ML) models, to generate personalized educational media content for the user. And at block 508, the method 500 includes performing, by the computing system, a set of operations to facilitate outputting for presentation via a user interface, the generated personalized educational media content for the user.

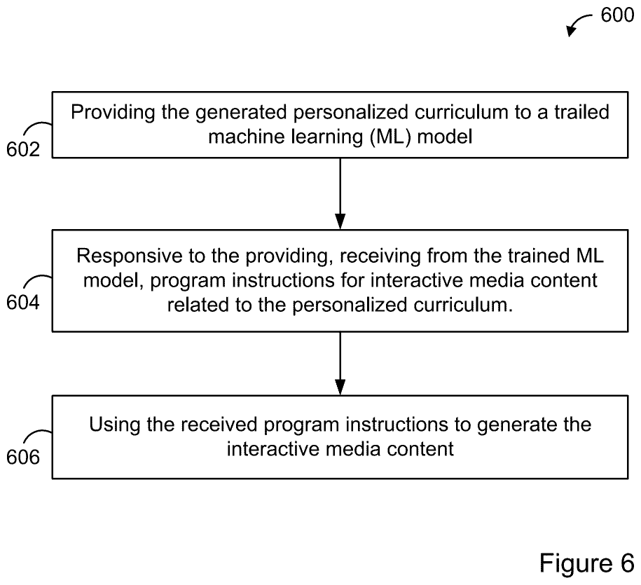

FIG. 6 is a flow chart illustrating an example method 600 for using at least the generated personalized curriculum and one or more trained ML models, to generate personalized educational media content for the user. The method 600 can be carried out by a content system, such as the content system 100, or by a component thereof, such as the content generator 102, or more generally, by a computing system, such as the computing system 200. At block 602, the method 600 includes providing the generated personalized curriculum to a trained ML model. At block 604, the method 600 includes responsive to the providing, receiving from the trained ML model, program instructions for interactive media content related to the personalized curriculum. At block 606, the method 600 includes using the received program instructions to generate the interactive media content.

In some examples, determining the extent of the user's understanding of one or more educational topics comprises, for each of the one or more educational topics, determining a respective score indicating the extent of the user's understanding of that educational topic.

In some examples, wherein determining the extent of the user's understanding of one or more educational topics comprises: (i) receiving user input indicating the extent of the user's understanding of one or more educational topics; and (ii) using the received user input to determine the extent of the user's understanding of one or more educational topics.

In some examples, determining the extent of the user's understanding of one or more educational topics comprises: (i) providing the user with a questionnaire and receiving corresponding user input indicating answers to the questionnaire; (ii) using the received user input to determine the extent of the user's understanding of one or more educational topics.

In some examples, the questionnaire is an adaptive test or a diagnostic test.

In some examples, determining the extent of the user's understanding of one or more educational topics comprises: (i) determining a content consumption history of the user; and (ii) using the determined content consumption history of the user to determine the extent of the user's understanding of one or more educational topics.

In some examples, determining the extent of the user's understanding of one or more educational topics comprises: (i) determining a content interaction history of the user; and (ii) using the determined content interaction history of the user to determine the extent of the user's understanding of one or more educational topics.

In some examples, determining the extent of the user's understanding of one or more educational topics comprises: (i) determining a content engagement history of the user; and (ii) using the determined content engagement history of the user to determine the extent of the user's understanding of one or more educational topics.

In some examples, using at least the determined extent of the user's understanding of one or more educational topics to generate the personalized curriculum for the user comprises: (i) providing at least the determined extent of the user's understanding of one or more educational topics to a trained ML model; and (ii) responsive to the providing, receiving from trained model, the generated personalized curriculum for the user.

In some examples, the method 500 further includes: using at least one of the one or more educational topics to identify a corresponding current event topic; wherein providing at least the determined extent of the user's understanding of one or more educational topics to a trained ML model comprises providing at least the determined extent of the user's understanding of one or more educational topics and the identified current event topic to the trained ML model.

In some examples, using at least the generated personalized curriculum and one or more trained ML models, to generate personalized educational media content for the user comprises: (i) providing the generated personalized curriculum to a trained ML model; (ii) responsive to the providing, receiving from the trained ML model, program instructions for interactive media content related to the personalized curriculum; and (iii) using the received program instructions to generate the interactive media content.

In some examples, using at least the generated personalized curriculum and one or more trained ML models, to generate personalized educational media content for the user comprises: (i) providing the generated personalized curriculum to a trained ML model; and (ii) responsive to the providing, receiving from the trained ML model, generated video content related to the personalized curriculum.

In some examples, providing at least the determined extent of the user's understanding of one or more educational topics to a trained ML model comprises providing at least the determined extent of the user's understanding of one or more educational topics and user profile data associated with the user to the trained ML model.

In some examples, the user profile data indicates user media content preference data.

In some examples, performing the set of operations to facilitate outputting for presentation via the user interface, the generated personalized educational media content for the user comprises transmitting the generated personalized educational media content to a content-presentation device.

In some examples, the content-presentation device is a television or a set-top box.

In some examples, performing the set of operations to facilitate outputting for presentation via the user interface, the generated personalized educational media content for the user comprises displaying the generated personalized educational media content.

### IV. Example Variations

Although some of the acts and/or functions described in this disclosure have been described as being performed by a particular entity, the acts and/or functions can be performed by any entity, such as those entities described in this disclosure. For example, some or all operations can be performed sever-side and/or client-side. Further, although the acts and/or functions have been recited in a particular order, the acts and/or functions need not be performed in the order recited. However, in some instances, it can be desired to perform the acts and/or functions in the order recited. Further, each of the acts and/or functions can be performed responsive to one or more of the other acts and/or functions. Also, not all of the acts and/or functions need to be performed to achieve one or more of the benefits provided by this disclosure, and therefore not all of the acts and/or functions are required.

Although certain variations have been discussed in connection with one or more examples of this disclosure, these variations can also be applied to all of the other examples of this disclosure as well.

Although select examples of this disclosure have been described, alterations and permutations of these examples will be apparent to those of ordinary skill in the art. Other changes, substitutions, and/or alterations are also possible without departing from the invention in its broader aspects as set forth in the following claims.

1. A method comprising:
determining, by a computing system, an extent of a user's understanding of one or more educational topics;
using, by the computing system, at least the determined extent of the user's understanding of one or more educational topics to generate a personalized curriculum for the user;
using, by the computing system, at least the generated personalized curriculum and one or more trained machine learning (ML) models, to generate personalized educational media content for the user; and
performing, by the computing system, a set of operations to facilitate outputting for presentation via a user interface, the generated personalized educational media content for the user.

2. The method of claim 1, wherein determining the extent of the user's understanding of one or more educational topics comprises, for each of the one or more educational topics, determining a respective score indicating the extent of the user's understanding of that educational topic.

3. The method of claim 1, wherein determining the extent of the user's understanding of one or more educational topics comprises:
receiving user input indicating the extent of the user's understanding of one or more educational topics; and
using the received user input to determine the extent of the user's understanding of one or more educational topics.

4. The method of claim 1, wherein determining the extent of the user's understanding of one or more educational topics comprises:
providing the user with a questionnaire and receiving corresponding user input indicating answers to the questionnaire; and
using the received user input to determine the extent of the user's understanding of one or more educational topics.

5. The method of claim 4, wherein the questionnaire is an adaptive test or a diagnostic test.

6. The method of claim 1, wherein determining the extent of the user's understanding of one or more educational topics comprises:
determining a content consumption history of the user; and
using the determined content consumption history of the user to determine the extent of the user's understanding of one or more educational topics.

7. The method of claim 1, wherein determining the extent of the user's understanding of one or more educational topics comprises:
determining a content interaction history of the user; and
using the determined content interaction history of the user to determine the extent of the user's understanding of one or more educational topics.

8. The method of claim 1, wherein determining the extent of the user's understanding of one or more educational topics comprises:
determining a content engagement history of the user; and
using the determined content engagement history of the user to determine the extent of the user's understanding of one or more educational topics.

9. The method of claim 1, wherein using at least the determined extent of the user's understanding of one or more educational topics to generate the personalized curriculum for the user comprises:
providing at least the determined extent of the user's understanding of one or more educational topics to a trained ML model; and
responsive to the providing, receiving from trained model, the generated personalized curriculum for the user.

10. The method of claim 9, further comprising:
using at least one of the one or more educational topics to identify a corresponding current event topic;
wherein providing at least the determined extent of the user's understanding of one or more educational topics to a trained ML model comprises providing at least the determined extent of the user's understanding of one or more educational topics and the identified current event topic to the trained ML model.

11. The method of claim 1, wherein using at least the generated personalized curriculum and one or more trained ML models, to generate personalized educational media content for the user comprises:
providing the generated personalized curriculum to a trained ML model;
responsive to the providing, receiving from the trained ML model, program instructions for interactive media content related to the personalized curriculum; and
using the received program instructions to generate the interactive media content.

12. The method of claim 1, wherein using at least the generated personalized curriculum and one or more trained ML models, to generate personalized educational media content for the user comprises:
providing the generated personalized curriculum to a trained ML model; and
responsive to the providing, receiving from the trained ML model, generated video content related to the personalized curriculum.

13. The method of claim 1, wherein providing at least the determined extent of the user's understanding of one or more educational topics to a trained ML model comprises providing at least the determined extent of the user's understanding of one or more educational topics and user profile data associated with the user to the trained ML model.

14. The method of claim 13, wherein the user profile data indicates user media content preference data.

15. The method of claim 1, wherein performing the set of operations to facilitate outputting for presentation via the user interface, the generated personalized educational media content for the user comprises transmitting the generated personalized educational media content to a content-presentation device.

16. The method of claim 15, wherein the content-presentation device is a television.

17. The method of claim 15, wherein the content-presentation device is a set-top box.

18. The method of claim 1, wherein performing the set of operations to facilitate outputting for presentation via the user interface, the generated personalized educational media content for the user comprises displaying the generated personalized educational media content.

19. A computing system comprising a processor and a non-transitory computer-readable medium having stored thereon program instructions that upon execution by the processor, cause performance of a set of acts comprising:
determining, by the computing system, an extent of a user's understanding of one or more educational topics;
using, by the computing system, at least the determined extent of the user's understanding of one or more educational topics to generate a personalized curriculum for the user;
using, by the computing system, at least the generated personalized curriculum and one or more trained machine learning (ML) models, to generate personalized educational media content for the user; and
performing, by the computing system, a set of operations to facilitate outputting for presentation via a user interface, the generated personalized educational media content for the user.

20. A non-transitory computer-readable medium having stored thereon program instructions that upon execution by a processor, cause performance of a set of acts comprising:
determining, by a computing system, an extent of a user's understanding of one or more educational topics;
using, by the computing system, at least the determined extent of the user's understanding of one or more educational topics to generate a personalized curriculum for the user;
using, by the computing system, at least the generated personalized curriculum and one or more trained machine learning (ML) models, to generate personalized educational media content for the user; and
performing, by the computing system, a set of operations to facilitate outputting for presentation via a user interface, the generated personalized educational media content for the user.
